(19) United States
(12) Patent Application Publication
(10) Pub. No.: US 2020/0038910 A1
(43) Pub. Date: Feb. 6, 2020

(54) LINEAR VIBRATION MOTOR

(71) Applicant: AAC Acoustic Technologies (Shenzhen) Co., Ltd., Shenzhen (CN)

(72) Inventors: Tao Zhang, Shenzhen (CN); Lubin Mao, Shenzhen (CN)

(21) Appl. No.: 16/526,956

(22) Filed: Jul. 30, 2019

(30) Foreign Application Priority Data
Aug. 3, 2018 (CN) 201821252428.5

(51) Int. Cl. B06B 1/04; H02K 33/14; H02K 35/02; H02K 5/04

(52) U.S. Cl. CPC B06B 1/045; H02K 5/04; H02K 35/02; H02K 33/14

(57) ABSTRACT

The present disclosure provides a linear vibration motor, including a base having an accommodating space, a vibration unit accommodated in the accommodating space, an elastic member that fixes and suspends the vibration unit in the accommodating space and a drive unit fixed to the base and configured to drive the vibration unit to vibrate along a direction perpendicular to a horizontal direction, herein the vibration unit includes a magnetic steel fixed to the elastic member; and the drive unit includes a coil fixed to the base, a winding plane of the coil being parallel to a vibration direction of the vibration unit. Compared with a related art, a linear vibration motor in the present disclosure has better vibration performance.

### TECHNICAL FIELD

The present disclosure relates to a motor, especially to a linear vibration motor applied to the mobile electronic products.

### BACKGROUND

With the development of electronic technology, portable consumptive electronic products such as mobile phones, handheld game machines, navigation devices and handheld multimedia entertainment devices are becoming increasingly popular. Generally, a linear vibration motor is used in an electronic device as described above to provide system feedbacks such as an incoming call alert, message reminder and navigation prompt of a mobile phone, or a vibration feedback of a game machine. Due to the extensive application, excellent performance and long life are required of a vibration motor.

A linear vibration motor in a related art includes a base having an accommodating space, a vibration unit located in the accommodating space, an elastic member that fixes and suspends the vibration unit in the accommodating space, and a coil fixed to the base. Interaction between electronic magnetic fields generated by the coil and vibration unit drives the vibration unit to linearly reciprocate to generate vibration.

However, in a structure in which the linear vibration motor in related technologies vibrates in a Z-axis direction, a winding plane of the coil is disposed as perpendicular to the vibration direction, and the coil surrounds a magnetic steel of the vibration unit. In this structure, since the coil surrounds the magnetic steel, a lateral side of the coil is large and utilization rate is low, resulting in a small force factor BL, thereby limiting vibration performance of the vibration motor.

Therefore, it is necessary to provide a new linear vibration motor to solve the above-described problem.

### BRIEF DESCRIPTION OF THE DRAWINGS

FIG. 1 is a schematic view showing a perspective structure of a linear vibration motor in the present disclosure;

FIG. 2 is a schematic exploded view showing a part of the structure of the linear vibration motor in the present disclosure;

FIG. 3 is a schematic cross-sectional view along a line A-A in FIG. 1.

### DETAILED DESCRIPTION

The present disclosure is described further as follows with reference to accompanying drawings and embodiments.

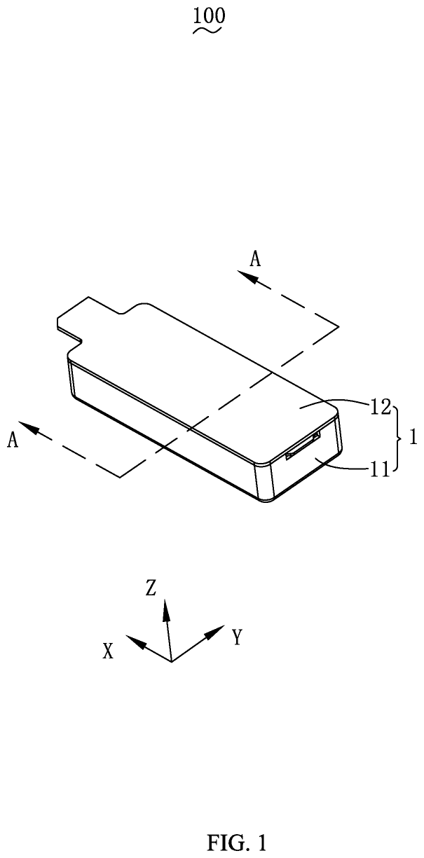

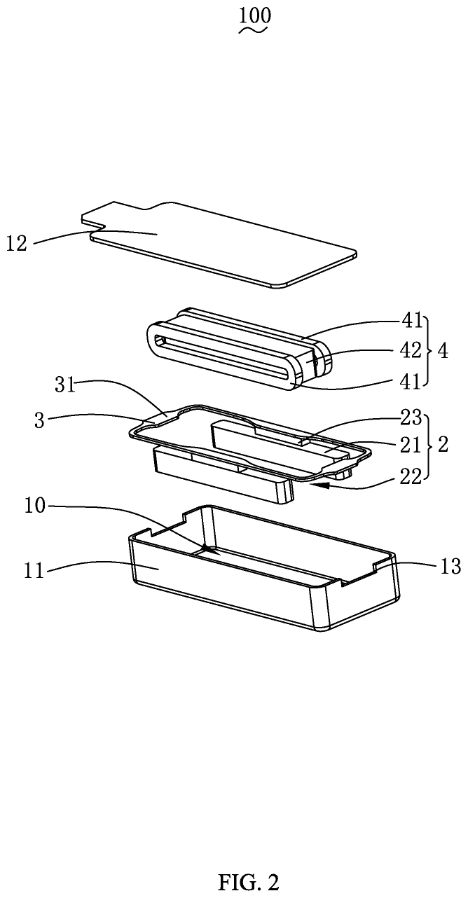

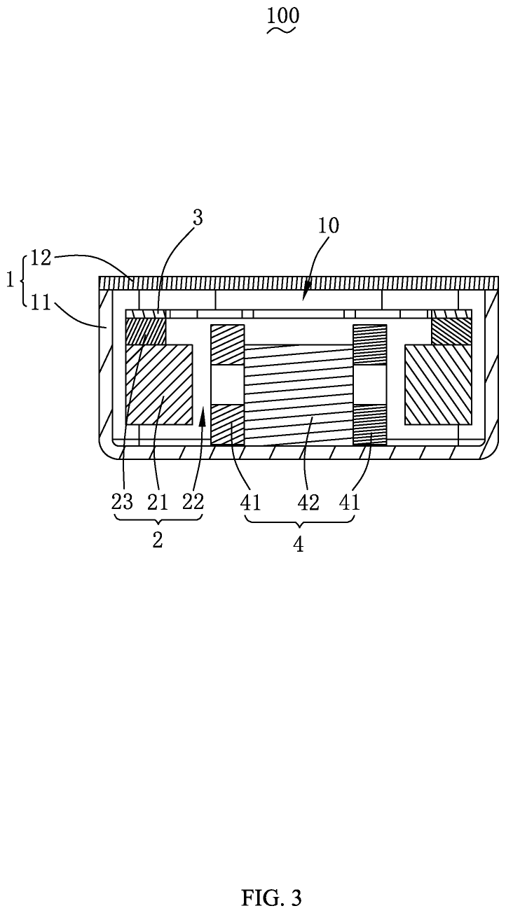

With reference to FIGS. 1-3, the present disclosure provides a linear vibration motor 100 including a base 1, a vibration unit 2, an elastic member 3 and a drive unit 4.

The base 1 includes a seat 11 and a cover plate 12 covering the seat 11. The seat 11 and the cover plate 12 enclose an accommodating space 10. The base 1 may be an integral structure or may be a separate structure. In this embodiment, that the base 1 is of a rectangle is taken as an example for description.

The vibration unit 2 is accommodated within the accommodating space 10. The vibration unit 2 includes a magnetic steel 21 fixed to the elastic member 3. In this embodiment, specifically, there are at least two the magnetic steels 21. Two of the magnetic steels 21 are parallel to each other and form a magnetic gap 22.

In order to reduce magnetic field loss of the magnetic steel 21, in this embodiment, the vibration unit 2 further includes a pole core 23 fixedly stacked on the magnetic steel 21 in a vibration direction of the vibration unit 2, and the pole core 23 is used for magnetic conduction.

In this embodiment, a magnetization direction of the magnetic steel 21 is parallel to the vibration direction of the magnetic steel 21.

The elastic member 3 fixes and suspends the vibration unit 2 in the accommodating space 10, which provides a precondition for the vibration unit 2 to vibrate. In this embodiment, the elastic member 3 is of an annular structure, fixed to a side, closer to the cover plate 12, of the seat 11. The magnetic steel 21 is fixed to the elastic member 3. That is, the magnetic steel 21 is fixed to the elastic member 3 through the pole core 23.

The drive unit 4 is fixed to the base 1 and is configured to drive the vibration unit 2 to vibrate in a direction perpendicular to a horizontal direction, i.e., being perpendicular to a plane formed by axes X and Y as shown in FIG. 1, thereby vibrating in a Z-axis direction.

In this embodiment, the drive unit 4 is located within the magnetic gap 22. Specifically, the drive unit 4 includes a coil 41 and an iron core 42.

A winding plane of the coil 41 is parallel to the vibration direction of the vibration unit 2. The magnetic steel 21 is magnetized in the vibration direction. Alternatively, magnetic induction lines may directly pass through the coil 41 to provide Lorentz force, so that a force factor BL is maximized, thereby efficiently improving vibration performance of the linear vibration motor 100.

Preferably, the winding plane of the coil 41 is parallel to a long axis direction of the base 1, so that the length of the coil 41 is as long as possible. Besides, since the winding plane of the coil 41 is provided as parallel to the vibration direction of the vibration unit 2, a long side of the coil 41 is longer and is located within the magnetic gap 22, so that more horizontally divided magnetism on an upper side and a lower side of the magnetic steel 21 may pass through the long side of the coil 41, thus improving the force factor BL and generating a larger drive force, which further improves the vibration performance of the linear vibration motor 100.

In this embodiment, there are two coils 41 and are respectively attached to two opposite sides of the iron core 42. The structure further increases the drive force and improves the vibration performance. Preferably, the two coils 41 are respectively fixedly attached to the iron core 42 and are respectively located between the iron core 42 and the two magnetic steels 21.

The iron core 42 is fixed to the base 1, for example, the iron core is fixed to the seat 11, which may improve the magnetic field and increase drive force of the drive unit 4, so that vibration performance of the vibration unit 2 is better.

Grooves 13 are provided in two opposite sides of a short axis of the base 1, and the elastic member 3 is provided with a protrusion 31 engaged in the grooves 13.

Compared with a related art, a vibration unit of a linear vibration motor in the present disclosure includes at least two magnetic steels fixed to an elastic member, a drive unit is located within a magnetic gap between the two magnetic steels, and the drive unit includes a coil and a winding plane of the coil is parallel to a vibration direction of the vibration unit. By making a magnetization direction of magnetic steels parallel to a vibration direction of the magnetic steels, horizontally divided magnetism on an upper side and a lower side of the magnetic steel may be able to pass through the coil to provide Lorentz force, thus maximizing a force factor BL and improving vibration performance of the linear vibration motor.

The above description is only an embodiment of the present disclosure, which does not impose a limitation to the scope of the present disclosure. Any equivalent structures or any equivalent step variants that are made by using the disclosure and the drawings of the present disclosure and that may be directly or indirectly applied to other related art are all included in the scope of patent protection of the present disclosure.

What is claimed is:

1. A linear vibration motor, comprising a base having an accommodating space, a vibration unit accommodated in the accommodating space, an elastic member that fixes and suspends the vibration unit in the accommodating space and a drive unit fixed to the base and configured to drive the vibration unit to vibrate along a direction perpendicular to a horizontal direction, wherein the vibration unit comprises a magnetic steel fixed to the elastic member; and the drive unit comprises a coil fixed to the base, a winding plane of the coil being parallel to a vibration direction of the vibration unit.

2. The linear vibration motor according to claim 1, wherein there are at least two magnetic steels, two of the magnetic steels are parallel to each other to form a magnetic gap, and the drive unit is located in the magnetic gap.

3. The linear vibration motor according to claim 2, wherein the drive unit further comprises an iron core fixed at the base, the coil fixedly attached to the iron core and located between the iron core and the magnetic steels.

4. The linear vibration motor according to claim 3, wherein there are two coils, and each of the two opposite sides of the iron core is attached with one of the coils.

5. The linear vibration motor according to claim 1, wherein the vibration unit further comprises a pole core fixedly stacked on the magnetic steel in a vibration direction of the vibration unit.

6. The linear vibration motor according to claim 5, wherein the elastic member is fixed to the pole core.

7. The linear vibration motor according to claim 1, wherein the base is of a rectangle, and the winding plane of the coil is parallel to a long axis direction of the base.

8. The linear vibration motor according to claim 7, wherein grooves are provided in two opposite sides of a short axis of the base, and the elastic member is provided with a protrusion engaged in the grooves.
